(19) United States
(12) Patent Application Publication
(10) Pub. No.: US 2005/0264447 A1
(43) Pub. Date: Dec. 1, 2005

(54) Structure for inverted F plane antenna

(76) Inventor: Chi-Shen Shan, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/854,343

(22) Filed: May 27, 2004

(51) Int. Cl. H01Q 1/38

(52) U.S. Cl. 343/700 MS

(57) ABSTRACT

The present invention is related to a structure for inverted F plane antenna, which is on a surface of a PCB by way of etching. The antenna comprises a pair of parallel sections constructed by a first parallel section, a second parallel section and a vertical section perpendicular to the two parallel sections, wherein the first parallel section connects to a grounding end of the PCB electrically, the second parallel section connects to a power end of the PCB, the vertical section has a bending portion with U shape to increase the length of receiving signals, therefore reflection signals may be highly decreased, and functions of receiving/emission stronger power are then achieved and receiving/emission band width is increased; further, under conditions of not extending the length of the vertical section and shrinking the volume of the antenna shall upgrade the convenience of the design.

### FIELD OF THE INVENTION

The present invention relates to a structure of an inverted F plane antenna and particularly to an inverted F plane antenna that has a greater operation bandwidth and a smaller size.

### BACKGROUND OF THE INVENTION

With rapid development of wireless communication technologies, 3C (consumption, communication and computer) products that are coupled with communication modules to form mobile communication products have become the main stream of the current technology products, such as notebook computer, PDA and the like. These products, after coupled with the communication module, not only can be connected to a local area network (LAN) to receive and transmit e-mail, also can receive instant information (such as instant news, stock quotations, etc.) to achieve resources sharing and data transmission functions. Inverted F plane antenna is small and light, thus is widely used as a built-in antenna of the mobile communication products..

Refer to FIG. 1 for a conventional inverted F plane antenna 11. It is formed on the surface of a printed circuit board (PCB) 10 by etching. The antenna 11 has a pair of parallel sections that include a first parallel section 12 and a second parallel section 12′, and a vertical section 13 perpendicular to the first and the second parallel sections 12 and 12′. The first parallel section 12 is electrically connected to a grounding end 14 of the PCB 10, while the second parallel section 12′ is electrically connected to a signal end 15 of the PCB 10. The antenna 11 thus constructed can receive and emit radio frequency (RF) signals.

However, the conventional inverted F plane antenna set forth above usually has a narrow operation bandwidth. Referring to FIG. 2, a test result shows that the bandwidth between Δ4˜Δ3 is merely 150 MHz. To increase the receiving and emission bandwidth, the length of the vertical section 13 has to be increased. This will increase the size of the inverted F plane and the size of the PCB 10. This is against the trend of the mobile communication product that requires a compact size.

### SUMMARY OF THE INVENTION

In view of the aforesaid disadvantages, the invention aims to provide a novel inverted F plane antenna structure to solve the problems occurred to the conventional techniques.

The object of the invention is to provide an inverted F plane antenna structure to meet the requirement of shrinking PCB of the prevailing trend.

Another object of the invention is to provide an inverted F plane antenna structure with increased operation bandwidth.

Yet another object of the invention is to provide an inverted F plane antenna structure to improve signal receiving and emission quality.

In order to achieve the foregoing objects, the inverted F plane antenna structure according to the invention is formed on the surface of a PCB by etching. It has a pair of parallel sections connecting by a vertical section. The first parallel section is electrically connected to a grounding end of the PCB, while the second parallel section is electrically connected to a signal end of the PCB. The vertical section has at least one bending section formed in U-shape to increase the total length of the antenna. Thereby reflection signals may be reduced and signals of a greater power range may be received and emitted. And the receiving and emission bandwidth increases. In addition, the antenna size may be shrunk to facilitate antenna design without increasing the length of the vertical section.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 of a schematic view of a conventional inverted F plane antenna.

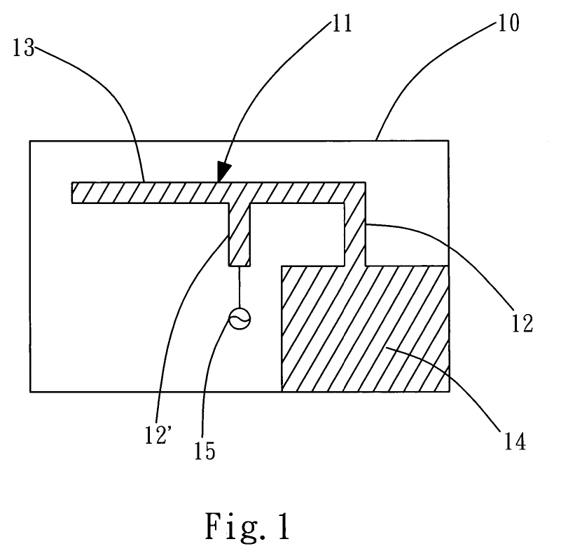

FIG. 2 is a chart showing test results of the bandwidth of a conventional inverted F plane antenna.

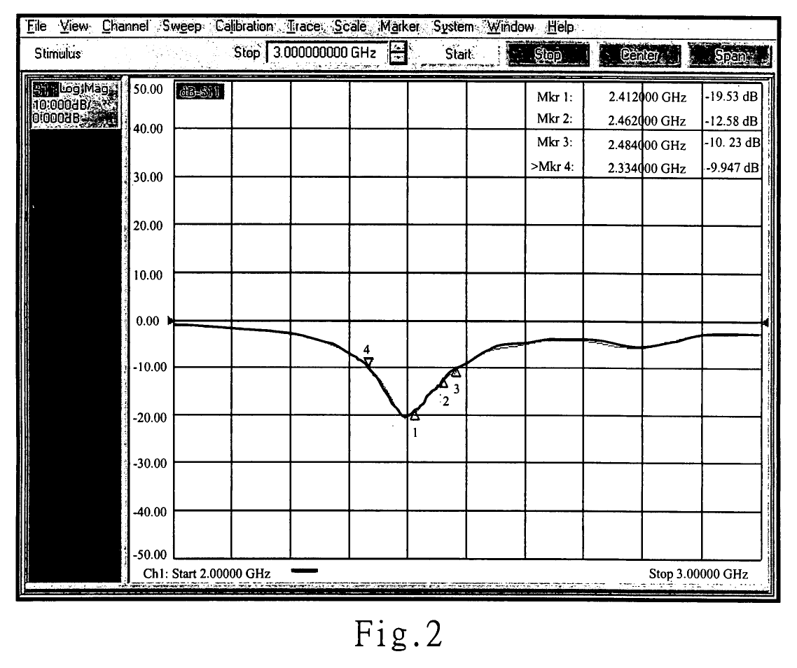

FIG. 3 is a schematic view of an inverted F plane antenna of the invention.

FIG. 4 is a chart showing test results of the bandwidth of the inverted F plane antenna of the invention.

### DESCRIPTION OF THE PREFERRED EMBODIMENT

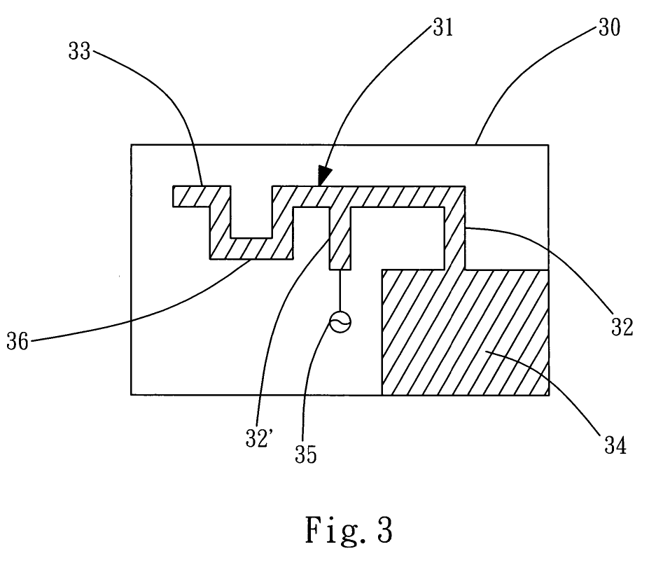

Referring to FIG. 3, the inverted F plane antenna structure according to the invention includes an inverted F plane antenna 31 formed on a surface of a PCB 30 by etching. The antenna 31 has a pair of parallel sections that include a first parallel section 32 and a second parallel section 32′ and a vertical section 33 connecting to the first parallel section 32 and the second parallel section 32′ in a perpendicular manner. The first parallel section 32 is electrically connected to a grounding end 34 of the PCB 30, while the second parallel section 32′ is electrically connected to a signal end 35 of the PCB 30. The vertical section 33 has at least one bending section 36 formed in U-shape to increase the total length of the antenna 31.

Because the total length of the antenna 31 increases, it can receive and emit signals of a lower frequency and a greater power range, and also increase the receiving and emission bandwidth. Therefore, the antenna size may be shrunk without increasing the length of the vertical section 33 to facilitate antenna design.

Referring to FIG. 3, the interval and depth of the bending section 36 determine the receiving and emission bandwidth, and the amount of signal reflection energy. Hence the size of the bending section 36 may be adjusted (or designed) based on actual receiving and emission bandwidth.

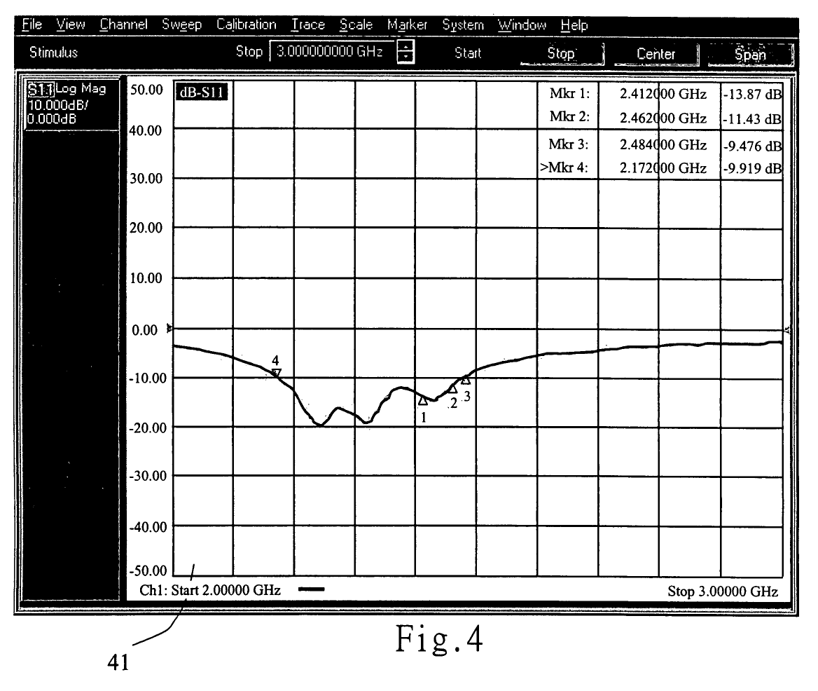

Referring to FIG. 4, the test results of the antenna 31 of the invention indicate that the bandwidth between Δ4˜Δ3 is 312 MHz. It more than doubles the range of the conventional one previously discussed. It proves that the antenna 31 of the invention can increase the receiving and emission bandwidth without increasing the length of the vertical section 33, and the size of the antenna may be shrunk. It offers a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An inverted F plane antenna structure having an inverted F plane antenna formed on a printed circuit board by etching, comprising:
a pair of parallel sections including a first parallel section and a second parallel section, the first parallel section being electrically connected to a grounding end of the printed circuit board, while the second parallel section being electrically connected to a signal end of the printed circuit board; and
a vertical section connected vertically to the two parallel sections having at least one bending section to increase receiving and emission bandwidth and total length of the antenna and reduce receiving and emission frequency of the antenna.

2. The inverted F plane antenna structure of claim 1, wherein the bending section is formed in U-shape.
